(19) United States
(12) Patent Application Publication
(10) Pub. No.: US 2022/0283036 A1
(43) Pub. Date: Sep. 8, 2022

(54) NON-UNIFORMITY CORRECTION SOURCE FOR INFRARED IMAGING SYSTEMS

(71) Applicant: BAE Systems Information and Electronic Systems Integration Inc., Nashua, NH (US)

(72) Inventors: Jonathan E. Everett, Lexington, MA (US); Julia L. Junkala, Harvard, MA (US)

(73) Assignee: BAE Systems Information and Electronic Systems Integration Inc., Nashua, NH (US)

(21) Appl. No.: 16/407,654

(22) Filed: May 9, 2019

(51) Int. Cl. G01J 5/53; G01J 5/80; H04N 5/33; H04N 5/365

(52) U.S. Cl. CPC G01J 5/53; G01J 5/80; H04N 5/33; H04N 5/3651; G01J 2005/0077

(57) ABSTRACT

An infrared imaging system is provided. The system includes a sensor configured to receive light emitted by a scene and at least a portion of scenic flux to generate image data, a light source configured to provide calibrating light to offset at least a portion of the scene flux, the light source positioned such that an output of the light source is at a pupil of the infrared imaging system, and at least one image processing device. The image processing device is configured to receive the image data generated by the infrared sensor, determine at least one change in the scenic flux as received by the infrared sensor, determine if the at least one change in the scenic flux results in a change in pixel response of the infrared sensor that exceeds a response threshold, and if the change in pixel response exceeds a threshold, generate an updated calibration table.

### FIELD OF THE DISCLOSURE

This disclosure relates to infrared imaging, and more specifically to updating non-uniformity calibration tables for infrared imaging.

### BACKGROUND

An infrared imaging system can operate in an environment where the system views a target scene through a window while the system is flying through the atmosphere. For example, an infrared imaging system can be used for missile-based imaging or other high-velocity imaging platforms (e.g., airplane-based platforms). Infrared imagers typically consist of an n×m sensor array of photon collecting cells producing an n×m array of output pixel values. Because these cells vary in their offset and gain responses to a given input flux, the digitization of their output will contain false pixel to pixel variations which must be corrected if this output is to accurately represent the input scene. Typical infrared imagers correct the pixel to pixel variation using n×m arrays of gain and offset correction values. In cases where the collecting cells' responses to flux does not change over time, these calibration tables can be calculated in the factory; however, in the more common case where the offset and/or gain responses do change over time, these calibration tables must be calculated either during or just prior to use. In this case they are typically generated using a uniform reference source that is introduced into the optical path of the imaging device, such as a shutter or a flag. In particular, a solenoid or motor driven shutter or flag (thin emissive metal plate) is moved into the path of the infrared camera, causing a spatially uniform, plate temperature dependent spectrum of radiation to be projected to the infrared camera's sensor. This technique is suitable in implementations and use-cases where: the imaged scene temperature is similar to the camera's internal temperature; the time when the camera is blind as a result of the movement of the plate is tolerable; only a single level of reference flux from a fixed plate temperature is required so as to update the offset correction (i.e. new gain correction coefficients are not necessary); and the negative impact of a moving mechanism is acceptable. However, there are several applications where this technique is not suitable, such as missile-based imaging systems.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples and are incorporated in and constitute a part of this specification but are not intended to limit the scope of the disclosure. The drawings, together with the remainder of the specification, serve to explain principles and operations of the described and claimed aspects and examples. For purposes of clarity, not every component may be labeled in every figure.

FIG. 1 depicts an example infrared imaging system, in accordance with an embodiment of the present disclosure.

FIG. 2 depicts an example infrared imaging system including a uniformity source, in accordance with an embodiment of the present disclosure.

FIG. 3 depicts an example circuit block diagram for a uniformity source, in accordance with an embodiment of the present disclosure.

FIGS. 4A and 4B depicts example positions for an output of a uniformity source, in accordance with an embodiment of the present disclosure.

FIG. 5A depicts an example process for generating background correlation and uniformity information, in accordance with an embodiment of the present disclosure.

FIG. 5B depicts a sample process for generating a non-uniformity calibration table as described in the process of FIG. 5A, in accordance with an embodiment of the present disclosure.

FIGS. 6A-6D illustrate various graphs showing individual pixel response and calibration information for an infrared imager, in accordance with an embodiment of the present disclosure.

FIG. 7 depicts a block diagram of an example architecture of a computing device, in accordance with an embodiment of present disclosure.

### DETAILED DESCRIPTION

Techniques for non-uniformity correction are provided for use in an infrared imaging system. For examples, the techniques as described herein are useful when the gain or offset response characteristics of an infrared imager can be observed to have changed so much that application of the current calibration tables no longer produce a sufficiently accurate representation of the input scene. The techniques as described herein are also useful when the currently observed scene conditions deviate from a calibration point so much (e.g., beyond a given threshold), that the use of the available calibration data (obtained, for example, during factory calibration) to provide non-uniformity correction of the current scene would be expected to be inaccurate.

The techniques as described herein are particularly well-suited, according to some embodiments, to an imaging system integrated into a missile or another high velocity platform for seeking and tracking the missile/platform position during its flight to a target or destination. Other high-speed applications can be benefit as well, as will be appreciated. In an embodiment, the on-board imaging system includes an infrared camera, a projecting optic, and an infrared light source. As will be appreciated in light of this disclosure, the infrared light source (e.g., LED) can be used for infrared camera response calibration to minimize residual non-uniformity correction errors in the image which arise from either the imaged scene light flux deviating from a calibration point, thereby reducing the applicability of the stored calibration data, or from drift in the offset and gain response of the camera's pixels since the time of initial calibration, which is typical for infrared imagers. The light source is projected into the optical path of the infrared camera (e.g., an infrared focal plane array) from a position located nominally at a pupil plane of the imaging system. To minimize both the target scene blocked by and the added emissions from the projection components, the light source can be coupled into a suitable transmission medium such as an optical fiber or waveguide or other light-guiding structure having a relatively small spatial cross-section with respect to the field of view of the projecting optic and camera. The output of the light-guiding structure can be positioned at the pupil plane with the output numerical aperture configured such that the pointing direction of the optical light-guiding structure subtends the field of view as seen by the camera from the pupil plane. To achieve a calibrated response from the camera, the light source can be tuned to one or more known intensity levels, and each pixel's response to each of those known intensity levels can be used to calculate the pixel-specific coefficients of the camera response function under the current conditions. The pixel-specific coefficients may be stored in, for example, n×m non-uniformity calibration tables. The calibration tables can then be used or otherwise made available to correct for non-uniformity, as will be appreciated.

An example infrared imaging system includes an infrared sensor configured to receive infrared light emitted by both target scene and background flux, an analog to digital converter (ADC) to turn the collected signal into image data values, and an infrared light source configured to provide calibrating light to adjust the background flux. The light source is positioned such that an output of the light source is at a pupil of the infrared imaging system. The response of the camera to the corresponding light source as described herein is not limited to a single spectral wavelength band. In an example, the light source includes a first infrared light source configured to output a first light signal at a first wavelength and a first output intensity, a second infrared light source configured to output a second light signal at a second wavelength and a second output intensity, and a beam combiner configured to combine the first light signal and the second light signal into a combined beam and direct the combined beam to a light-guide structure, wherein the light-guide structure is configured to transmit the combined beam from the beam combiner to the pupil of the infrared imaging system. The infrared imaging system can further include at least one image processing device configured to receive the image data generated by the infrared sensor and ADC, calculate the input scenic flux for each wavelength, and determine whether the scene fluxes are sufficiently corrected by the pixel response function coefficients of the closest calibration tables. If the processing device determines that the scene fluxes are not sufficiently corrected by the pixel response function coefficients of the closest calibration tables, the system can generate (an) updated calibration table(s) for the infrared imaging system.

### General Overview

When subjected to dynamic environments such as for a missile seeking a target, the response uniformity of a camera in an on-board infrared imaging system can be impacted by changes in pixel-to-pixel response to the infrared light collected by the imaging system. Left uncorrected, any pixel-to-pixel-response non-uniformity of a given infrared imaging system (and particularly with respect to cooled infrared imaging systems) substantially limits the ability to get an accurate understanding of the flux distribution of an imaged scene. The pixel-to-pixel differences, in their offset and gain response, can form a veiling image overlaid onto a target scene image, reducing the ability to discern objects in the underlying image, particularly low contrast ones that may be of interest. This fixed pattern noise can be addressed by characterizing the response function at each pixel and correcting for the degradation to the image resulting from pixel-to-pixel variations. This calibration process is generally referred to as non-uniformity correction.

Further, once an infrared imaging system is calibrated with respect to a specific set of scene intensities, a non-uniformity of response can re-emerge as a fixed pattern noise and degrade the ability to interpret the image. The non-uniformity correction approach typically makes assumptions about how the camera response changes with respect to input flux. Often a linear response is assumed over a set flux range and at least two calibration flux levels are chosen against which the camera response at those levels is measured. In such an example offset and gain terms are calculated for each pixel such that the corrected output of the pixels at either of these calibration flux levels is the same for every pixel. This two-point non-uniformity correction is applied to correct for scene flux levels between the two selected calibration fluxes, and typically also just above and below the flux interval. The non-uniformity correction data is therefore most directly applicable when imagining scenes with the same flux as the calibration points. Because the assumption of linearity is only approximate, imaged flux levels that differ from the calibration levels can only be imperfectly corrected, typically with a residual non-uniformity correction error that increases depending on how far the flux level is from a calibration point. Drift of the pixel offset and gain response over time can also be an additional source of residual error.

In practice there are a number of challenges to creating calibration coefficients for a pixel's response to a known flux that is meant to be close to the flux of a later imaged scene. Generally, the attempt is made by, for example: 1) a factory or manufacturer calibration of the system response under anticipated operational and scene flux conditions, creating gain and offset correction coefficients for each pixel; and 2) replacing the factory calibration offset calibration coefficients via a periodic imaging of the uniform flux from an electro-mechanical metal flag or shutter at the camera's internal ambient temperature that is brought into position near the pupil, creating new offset correction coefficients from the pixel-to-pixel variations in response.

However, offset correction coefficients created for the ambient camera temperature flux may not necessarily correct offset non-uniformities at the higher flux level of the target. In the case where pixel gains have drifted, the new offset correction coefficients will perforce include correction for drift in gain, and so can have useful “accuracy” only near the temperature at which they are calculated. Missile-based seeking or imaging is an application where the mean scene temperature is relatively much lower than, and the target to be examined much higher than, the camera's internal ambient temperature. In addition, there are several applications where using a mechanically operated component to generate the scene used to perform a fresh offset calibration can negatively impact the ability of the imaging system to acquire images accurately and in a timely manner. For missile-based imaging, the operational period is too brief and dynamic to tolerate seconds of non-imaging calibration time, and the limited reliability of a moving mechanism in a high shock and vibration environment is too negatively impactful and thus not practical. As such, the techniques as described herein use an on-demand calibration source type with no necessary moving parts.

System and Device Architecture

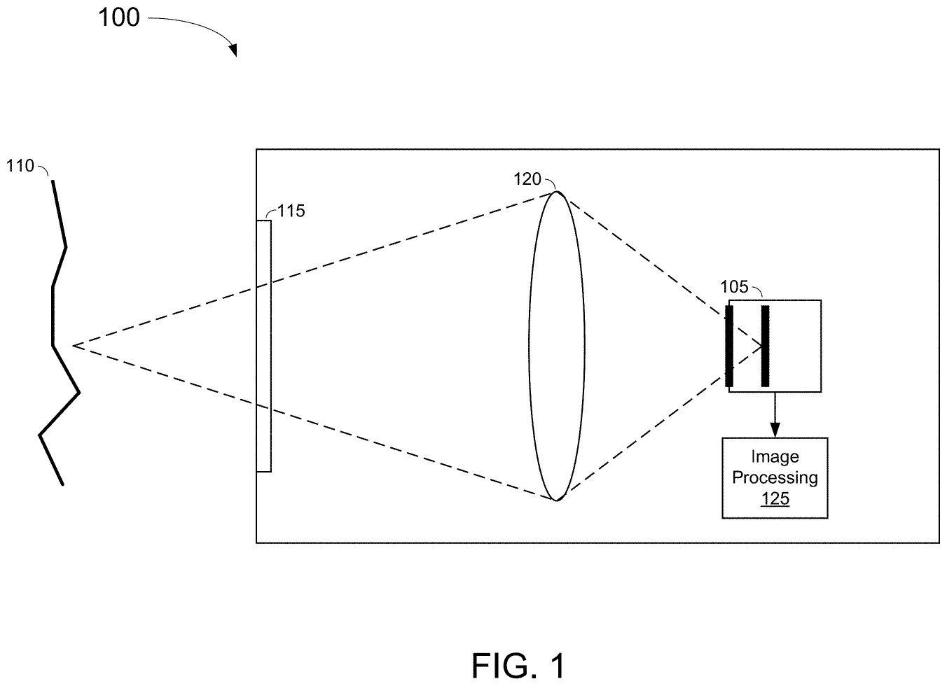

FIG. 1 illustrates an example system 100 that can be integrated, for example, into a missile for imaging a target during the missile's flight. The system 100 can include an imaging device such as an infrared imaging device 105 that is configured to capture images of a target scene 110 as the missile approaches its target. Depending upon the design of the system 100, the infrared imaging device can be configured to capture light emitted by the target scene 110 as it passes through window 115. In some examples, during operation such as high-speed flight, the window 115 can heat up as a result of friction, introducing changing background flux into the infrared imaging device 105. In some examples, the range of possible flux from the window may be quite large; it depends on factors such as ambient temperature at the time of launch, the altitude at the launch point and/or the altitude when the window 115 is exposed to atmospheric friction, and the overall flight path through the atmosphere. It may be impractical to predict and generate calibration data for an imager under all possible scenarios.

It should be noted that the window 115 is shown by way of example only and, in some examples, the window can be generalized to any aperture or path providing a line of sight between the infrared imaging device 105 and the target scene 110.

Additionally, as shown in FIG. 1, a re-imaging optical system 120 can be positioned between the infrared imaging device 105 and the window 115 (or, absent a window, between the infrared imaging device and the target scene 110). As shown in the example embodiment of FIG. 1, the re-imaging optical system 120 includes a single lens diffractive system. It should be noted however, that this is shown by way of example only. In certain implementations, a re-imaging optical system such as 120 can include diffractive and/or reflective elements and can include multiple optical elements. To this end, the optical pathway of the re-imaging optical system 120 can vary from one embodiment to the next, and the present disclosure is not intended to be limited to any particular one.

In system 100 as shown in FIG. 1, the infrared imaging device 105 observes a summation of any flux from the target scene 110, background flux from the window 115, and optical path flux resulting from the re-imaging optical system 120. An imaging processing system 125 can be operably coupled to the infrared imaging device 105 and configured to process the output of the infrared imaging device. However, without a way to compensate for background flux, the image processing device 125 is unable to account for non-uniformity in the imaging data, thereby reducing the quality and reliability of any produced images.

In order to account for non-uniformity in the imaging data, and as will be appreciated in light of this disclosure, an infrared imaging system can include a calibration source that provides, for example, controllable irradiation levels that provide for updating non-uniformity calibration tables of a mono or multiband infrared imager. In certain implementations that include a two-color infrared focal plane array (FPA), the FPA can be illuminated with light from a pair of infrared LEDs, each within a color band of interest. The LEDs can be coupled into a light-guide structure that won't impair the system's 120 field of view, such as a multimodal optical fiber, and projected from one of the imaging system's pupils. This approach enables a non-uniformity calibration source that is all solid-state, that can provide calibration information in a single camera frame with multi-spectral illumination, has controlled effective temperatures, and is minimally invasive. As will be further appreciated, the uniformity of the FPA illumination can be tailored by adjusting various factors such as, for example, the LED coupling angles, fiber optic core diameter, and fiber optic projection angle.

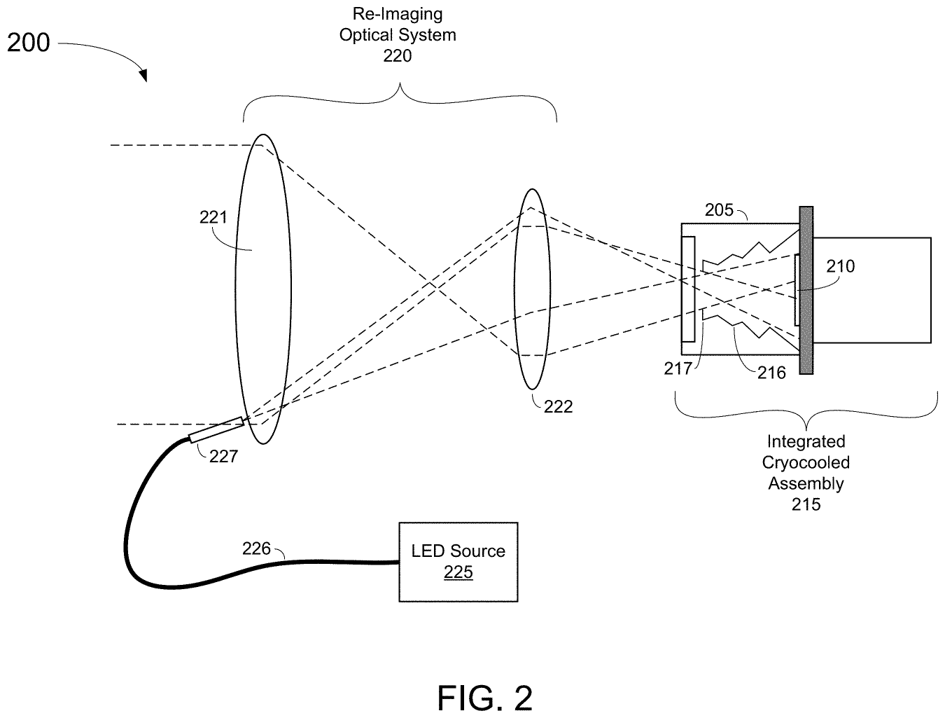

FIG. 2 illustrates an example imaging system 200 that includes a calibration source as described herein. As shown in FIG. 2, the example system 200 includes a camera 205 that includes, for example, a two-color FPA 210 configured to receive infrared light that is directed into the camera and collect image data of a target scene (e.g., target scene 110 as discussed above in regard to FIG. 1). In certain implementations, the camera 205 can be included in an integrated cryocooled assembly 215 that is configured to maintain the camera and its associated components at as cool a temperature as possible in order to reduce any flux caused by heat emitted by the internal camera elements. In certain implementations, the integrated cryocooled assembly 215 can include a Dewar vacuum assembly configured to keep the camera 205 as cold as possible, thereby minimizing any added flux from the camera components. Note, however, that other embodiments may be implemented with a non-cooled camera.

As further shown in FIG. 2, the camera can include a set of metal baffles 216 coupled to the same backplane as the FPA 210 and configured to be at the same operating ambient temperature as the FPA. The size and shape of the baffles 216 can define a cold stop 217 that forms an aperture in the integrated cooling assembly 215 that allows only photons travelling along the desired lines of sight to pass through the baffles to the FPA 210. By controlling the geometry of the baffles 216 and the size of the cold stop 217, flux from camera components, both direct and reflected, can be reduced or eliminated.

As further shown in FIG. 2, the system 200 can include a re-imaging optical system 220 positioned adjacent to the camera 205 and configured to angle incoming light such that only incoming photons from the desired line of sight are directed through the cold stop 217 and onto the FPA 210. In certain implementations, the re-imaging optical system 220 can include one or more lenses configured to adjust the angle of received light. For example, as shown in FIG. 2, the re-imaging optical system 220 includes a first diffractive lens 221 configured to redirect only those photons arriving orthogonal to it toward a second diffractive lens 222. The second diffractive lens 222 can be configured to adjust the angle of the received light such that the light is directed through the cold stop 217 and onto the FPA 210. However, it should be noted that two diffractive lenses as shown in FIG. 2 is by way of example only. In some examples, a re-imaging optical system such as 220 can include various numbers of lenses. Similarly, depending upon the geometry of the overall imaging system, a re-imaging optical system can include diffractive and/or reflective lenses that are configured and arranged to direct collected light to the camera. To this end, the complexity of the optical path associated with the re-imaging optical system 220 can vary from one embodiment to the next, depending on the given application.

Referring back to FIG. 2, the system 200 can further include a calibration source that is configured to provide a reference infrared light signal that can be adjusted during imaging to correct for any non-uniformity detected by the camera 205. For example, the calibration source can include an infrared LED light source 225 configured to generate, for example, a multiband light output. Note that the LED light source 225 may include one or more LEDs, each to provide a desired spectrum or color of light. In one such embodiment, two LEDs are provided to provide first and second bands of light. The output of the LED source 225 can be directed through, for example, a multimodal optical fiber 226. For example, the multimodal optical fiber 226 can be multimodal chalcogenide fiber. The multimodal optical fiber 226 can terminate in a stiffening ferrule 227. The stiffening ferrule 227 can be cleaved and positioned such that light generated by the LED source 225 is directed into the re-imaging optical system 220 and directed by the re-imaging optical system to the camera 205. As such, the FPA 210 can be illuminated by light generated and emitted by the LED source 225. As previously noted, however, other light-guide structures can be used, such as a waveguide, one or more mirrors, or other optical components suitable for directly light into the re-imaging optical system 220.

As shown in the example embodiment of FIG. 2, the stiffening ferrule 227 can be positioned so as to be minimally invasive within the path of collected light that is being directed to the camera 205 and the cold stop 217. As noted above, a component that is positioned within the path of the collected light can have a higher ambient temperature than the other components in the system and, as such, can emit unwanted infrared light into the system. By positioning the stiffening ferrule 227 in as minimally invasive a position as possible (e.g., to the side of the entrance pupil of the re-imaging optical system 220 as shown in FIG. 2), any flux caused by the stiffening ferrule 227 can be minimalized. For example, the stiffening ferrule 227 can have an outer diameter of 1 mm. The lens 221 of the re-imaging optical system can have a 50 mm aperture diameter. In such an example embodiment, the stiffening ferrule 227 would cover about 0.04% of the available aperture of the lens 221.

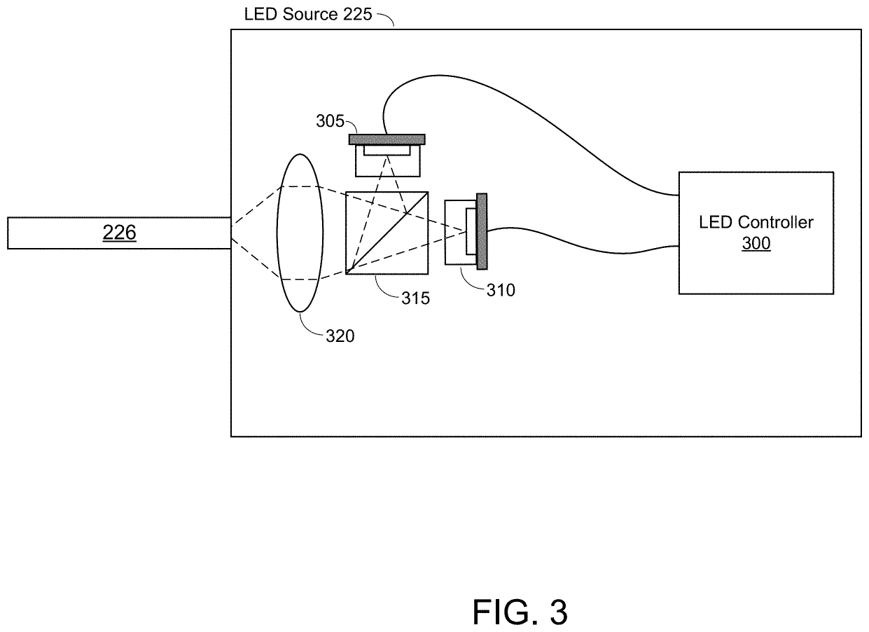

FIG. 3 illustrates an example circuit block diagram for an implementation of the LED source 225. As shown in FIG. 3, the LED source 225 can include an LED controller 300. The LED controller 300 can be operably coupled to, for example, one or more infrared LEDs. As shown in FIG. 3, a set of two LEDs 305 and 310 can be operably coupled to the LED controller. Each of LEDs 305 and 310 can be configured to output a particular wavelength of infrared light. For example, each of the LEDs 305 and 310 can be configured to output light having a wavelength between about 3.85 μm and about 3.94 μm. In certain implementations, the LEDs 305 and 310 can be configured to output different wavelengths. For example, LED 305 can be configured to output a wavelength of about 3.85 μm and LED 310 can be configured to output a wavelength of about 3.94 μm. In some examples, each of LEDs 305 and 310 can be configured to output the same wavelength. For example, each of the LEDs 305 and 310 can be configured to output a wavelength of about 3.90 μm.

Additionally, each of the LEDs 305 and 310 can be configured to output a particular operational intensity. For example, each of the LEDs 305 and 310 can be configured to output a signal between about 180 mW and about 220 mW. In certain implementations, each of the LEDs 305 and 310 can be configured to output a different signal intensity. For example, LED 305 can be configured to output a signal intensity of about 180 mW while LED 310 is configured to output a signal intensity of about 220 mW. In some examples, in response to an instruction from controller 300, one or both of LEDs 305 and 310 can be configured to alter their signal intensities during operation.

As further shown in FIG. 3, the output of each of LEDs 305 and 310 can be directed into a beam combiner 315. For example, as shown in FIG. 3, the beam combiner 315 can be a cube or other similarly shaped combiner configured to reflect and/or diffract the outputs of each of LEDs 305 and 310. In some examples, the beam combiner 315 can be a dichroic beam combiner. The output combined beam of the beam combiner 315 can be directed to a relay lens 320 which is configured to project the combined infrared beam into the multimodal optic fiber 226 (or another non-invasive light-guide structure). It should be noted that the beam combiner 315 and relay lens 320 are shown as separate components in FIG. 3 by way of example only. In some examples, both the beam combiner 315 and the lens 320 can be included in a single component configured to combine and direct the outputs of the LEDs 305 and 310. It should also be noted that two light sources LEDs 305 and 310 are shown by way of example only. In some examples, other numbers of light sources can be used based upon the type of focal plane array included in the imaging system. For example, a single light source can be used if the focal plan array is configured to detect a single wavelength. In certain implementations, the focal plane array can be configured to detect more than two wavelengths. In such an example, more than two light emitting devices (e.g., infrared LEDs) can be included in the light source.

In certain implementations, the LED controller 300 can be operably connected to a processing device such as an image processing device (e.g., image processing device 125 as shown in FIG. 1) and configured to receive information from the processing device. For example, the LED controller can receive an instruction from the processing device to change the output intensity of one or both of the LEDs 305 and 310.

It should be noted that, as described above, the infrared system as shown in FIG. 2 includes re-imaging optics by way of example only. In certain implementations, where an entrance pupil is an accessible location from which to project calibration light, the typical pupil magnification can result in a smaller projected cross-section of the calibration source optics at the cold stop aperture. This can allow the calibration source to project from a location that is better suited for uniformity at the image plane while facilitating the management of stray emissions from the calibration optics. Such an arrangement is illustrated in FIG. 2, for example, where the calibration source optics are positioned at the pupil plane of the re-imaging optical system.

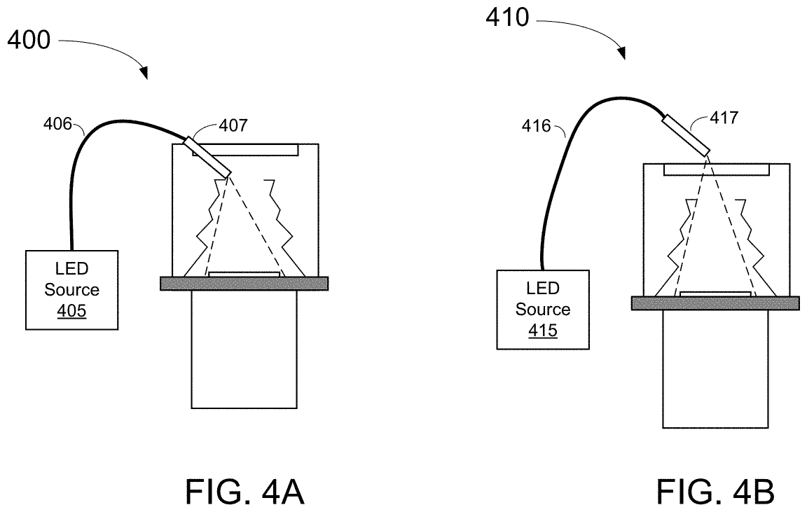

However, in some examples, the calibration source optics can be projected directly from or close to the cold stop aperture of the infrared imaging system without using a re-imaging optical system. For example, the output of the calibration source can be directly inserted into a vacuum assembly of the infrared imaging device and positioned adjacent to the cold stop aperture. As shown in FIG. 4A, an arrangement 400 can include an LED source that can be operably connected to a multimodal optical fiber 406 that terminates in a stiffening ferrule 407. In certain implementations, the stiffening ferrule 407 can be inserted into the vacuum assembly of the infrared imaging device and positioned adjacent to the cold stop aperture. As can be seen in FIG. 4A, the stiffening ferrule can be positioned and cleaved such that the output of the LED source 405 illuminates the FPA of the camera while the stiffening ferrule blocks a minimum amount of the cold stop aperture, thereby reducing any background flux introduced by the stiffening ferrule as well as reducing any collected light from, for example, a re-imaging optical system as shown in FIG. 2. Additionally, as the stiffening ferrule 407 is included within the vacuum assembly of the cryocooled infrared imaging device, the operating temperature of the stiffening ferrule is at or about at the same operating temperature as the other components of the camera (e.g., the baffle and the FPA) and, as such, additional background flux from a higher temperature component is eliminated.

However, in order to include the stiffening ferrule 407 in the vacuum assembly, the vacuum assembly may be modified to include an opening for the stiffening ferrule. Similarly, to provide atmospheric integrity for the vacuum assembly, the opening around the stiffening ferrule can be sealed and/or insulated.

FIG. 4B illustrates an alternative arrangement 410 for including a calibration source without positioning the output of the calibration source adjacent to a lens in a re-imaging optical system as is shown and described above in regard to FIG. 2. Rather, as shown in FIG. 4B, an LED source 415 can be operably coupled to a multimodal optical fiber 416 that terminates in a stiffening ferrule 417. The stiffening ferrule 417 can be placed adjacent to, for example, the vacuum assembly of the infrared imaging device. As shown in FIG. 4B, the stiffening ferrule 417 can be positioned and cleaved such that the output of the LED source is directed to illuminate the FPA of the infrared imaging device while maintaining the initial integrity of the vacuum assembly. Such an arrangement as that shown in FIG. 4B can be used when, for example, spatial requirements do not permit the use of a re-imaging optical system and the vacuum assembly of the infrared imaging device cannot be modified to accept the stiffening ferrule as is shown, for example, in FIG. 4A.

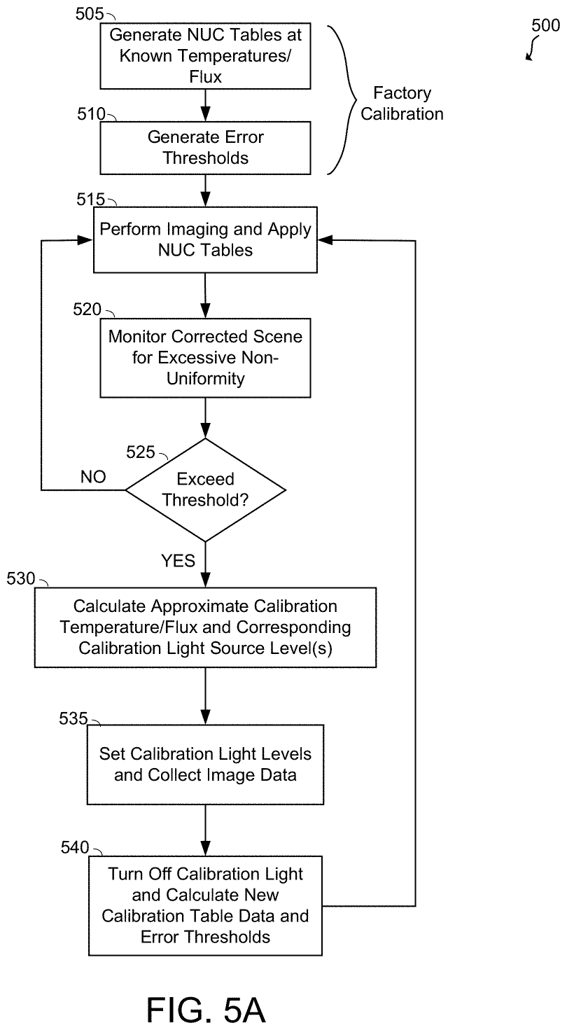

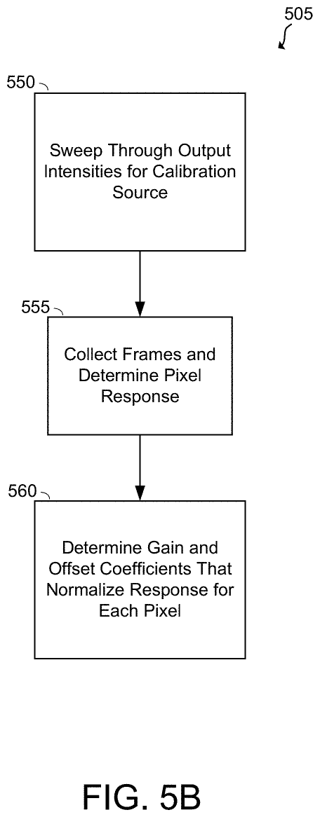

FIG. 5A illustrates a sample process 500 that can be used for operating a system, similar to that as shown in FIG. 2, which includes a non-uniformity calibration system such as that as described herein. The process 500 as shown in FIG. 5A and described herein can be implemented, for example, by a computing device such as the imaging processing device 125 as described above in regard to FIG. 1. In some examples, the process can include an initial portion that can be performed, for example, during manufacture of the imaging system and can include factory calibration of the infrared imager. As shown in FIG. 5A, the factory calibration can include generating 505 multiple offset and gain calibration tables to be applied at specified temperatures and/or flux levels.

FIG. 5B illustrates an example expanded process for generating 505 calibration tables as described above. The computing device can provide one or more instructions to a calibration source to sweep 550 or otherwise step through enough output flux intensities (calibration points) to ensure that no intensity level present during actual operation of the system will be unacceptably far from a calibration point. As noted above, a calibration source can include two infrared LEDs that are each configured to output a signal at varying intensities. In response to the instructions from the computing device, the calibration source can step through each output intensity for each of the two infrared LEDs. As the calibration source pauses at each output intensity of the sweep 550, the computing device can be configured to collect 555 digitized frames of video data and determine the infrared camera response on a pixel-to-pixel basis, and also to calculate the flux level for that intensity. Once all the data has been collected, equations can be generated for each pixel that determine the actual pixel response against flux.

Depending upon the speed of the computing device, the number of pixels in the focal plane, and the number of frames that must be collected to perform the calibration algorithm, a similar process as that shown in FIG. 5B may be able to be performed quickly upon initialization of the infrared imaging system. Time to complete this procedure would be largely dependent on the total frame collection time, which would depend on the frame period, number of frames required to be collected at each intensity, and number of intensities at which data must be collected. Typically, an infrared imager operates with frame periods from 33 ms to quicker than 1 ms, with some non-zero fraction of that time during which no image illumination is acquired. The determination of the pixel response characteristics of the infrared imager from the frame data is typically a small fraction of the total calibration time, and most calculations can generally be done while waiting for the next set of frames to be collected. Inclusion of the complete calibration procedure at initialization would depend on how quickly after initialization the system must be operational.

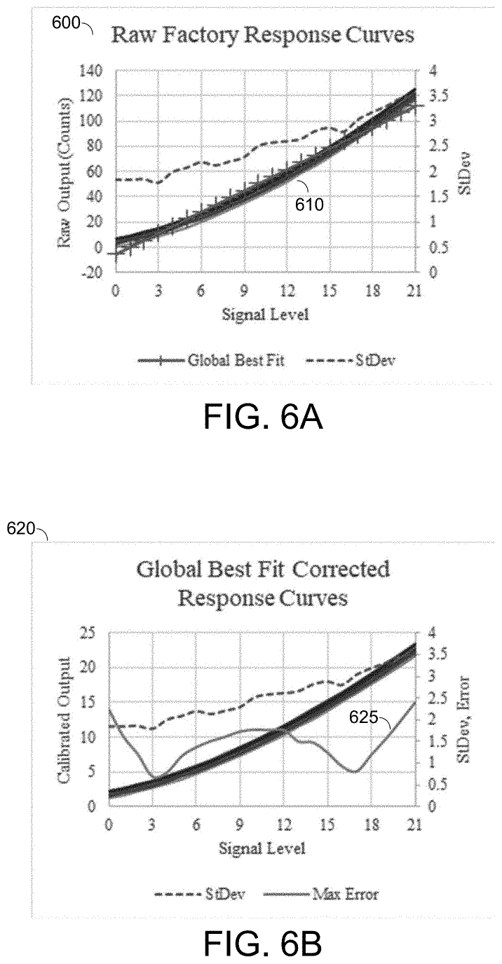

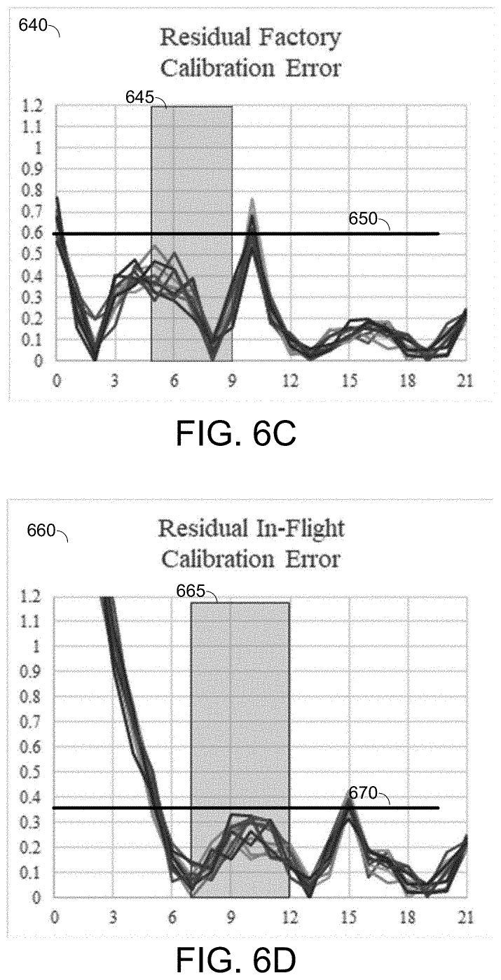

For example, the response characteristics of the infrared imager can be measured and illustrated in a line graph, as shown in FIG. 6A, in which the output response for eleven hypothetical pixels is plotted in graph 600. The raw digitalized response over a signal (flux) level 0 to 21 ranges from about zero to about 120 counts, and the average response of the eleven pixels can be approximated by the line 610, which has the form rₐ=ms+b, where s is the signal and rₐ is the average response. It should be noted that in FIGS. 6A-6D, both sets of units in the example graphs are nominal, and the numbers shown in the graphs are chosen are for demonstration purposes only. Using this equation and the particular response of each pixel rₚ, new equations of the form rₐ=mₚrₚ+bₚ can be generated for each pixel, allowing us to convert particular (erroneous) pixel values to corrected values

As further shown in FIG. 6A, the pixel response curves approximated by the line 610 are not perfectly linear. The error of the gain and offset coefficients can be shown in a plot of the residuals, the deltas between actual values and the calculated values. Because the best fit line will intersect the pixel response curves at two points, the gain and offset coefficients will clearly be most accurate at those points; and as shown in graph 620 of FIG. 6B, the residual curve 625 will have a “W” shape, which is a common characteristic for linearly corrected infrared focal planes. Depending upon the application, the errors for portions of the full range may be too great to be useful or otherwise meet the needs of the imaging application.

To reduce the size of the residuals, the response values can be calibrated piece-wise. For the example shown in FIG. 6A, the response for each pixel can be measured in two pieces, for signal levels between 0 and 10 and for signal levels between 11 and 21. Approximating these piece-wise curves as two linear equations of the form rₐ=ms+b, coefficients m and b can be determined for each piece. From these equations and the particular response of each pixel rₚ, two new piece-wise equations of the form rₐ=mₚrₚbₚ can be generated for each pixel, mapping uncorrected pixel response to corrected pixel response for each signal range. These mₚ values are the pixel-specific gain coefficients over that subrange of signal and can be stored as the gain calibration table for that subrange of signal; depending upon the stability of the offsets, i.e., the usefulness of stored offset coefficients, the bₚ values might similarly be stored as an offset calibration table.

Referring back to FIG. 5A, during the factory calibration, process 500 can also include generating 510 a set of error thresholds for determining non-uniformity calibration table accuracy at a particular flux level, to be used for monitoring the corrected scene for failure of the currently applied non-uniformity calibration tables (abbreviated as NUC Tables in FIG. 5A). Non-uniformity calibration tables can be inaccurate for two major reasons: first, because the current flux level is too far from the calibration points and the residual errors are expected to exceed a determined threshold, usually the edges of the “W” shape; and secondly, because the response/behavior of the focal plane photon collection cells, electronics, or digitizer has changed since calibration, with the result that the stored pixel offsets and/or gains no longer correct the image and may even make it worse. The first problem can be detected by determining whether the current flux is too far away from the nearest calibration flux, using delta flux thresholds for each set of calibration tables.

The second type of failure, drift of imaging system pixel response, can be detected in two ways. The first is by examining the corrected imaging system response to a known signal intensity and determining whether the absolute response error exceeds some threshold; this is generally not possible for certain imaging systems, such as missiles in flight, which cannot create a uniform background of known flux level to use as input to the imaging system. However, the embodiments described herein can be used to determine whether the average response has changed. This system can calculate the supposed current background flux from the average background response (counts); calculate and command a light level to add a known delta flux; measure the average response to this new flux; calculate the expected average response to this new flux (using the previously established average gain value); and finally, determine whether the delta between the actual and calculated average response exceeds a threshold, triggering a recalibration.

In addition to the above method, which determines whether there has been a change in overall average imaging system response, there is a second method of determining non-uniformity calibration table failure that measures how much individual pixels' responses have drifted away from each other. In this method, the processing device examines the pixel to pixel differences for corrected pixels known to be subject to identical input intensities, whether by using a large area known to receive only background flux; or, in a case where there is a non-uniform scene, by shifting the imaging device in object space so as to collect information about specific sample points in object space from multiple pixels. If the average standard deviation of these values exceeds a determined threshold, for example the maximum standard deviation allowable at that average flux level, the non-uniformity calibration tables are determined to be insufficiently accurate, triggering a recalibration.

Referring again to FIG. 5A, upon initialization of the imaging system (e.g., upon cooling of the focal plane or stabilization of the thermal electric cooler required for operation of the particular imaging system), the processor can begin the imaging process and apply 515 the non-uniformity calibration tables, and it can periodically monitor 520 the accuracy of the currently applied calibration tables as described above. If the processor determines 525 that the accuracy of these tables is no longer sufficient (e.g., the accuracy exceeds an error threshold), it can perform 530 a partial calibration. For example, as shown in FIG. 6C, if the signal level leaves the range of interest 645, exceeding a signal level of 9, the scene flux will cause an average pixel response whose residuals are above the error threshold 650, and a new calibration should be performed for the current signal level.

In such an example, and provided that the imaging device in this embodiment can be temporarily pointed at a featureless background, the processing device can perform a calibration from calibration temperatures/flux levels corresponding to 1) the current background flux, 2) the maximum estimated scene flux, and optionally 3) a flux value in between. Based upon the calculations, the computing device can step through 535 these light levels, pausing to collect image data at each level. The computing device can then turn off the calibration light source and process 540 the collected image data to calculate new mₚ and bₚ values for the pixel normalization equation rₐ=mₚrₚ+bₚ, as well as a new flux threshold for determining future flux range problems. For example, as shown in FIG. 6D, using these new calibration tables will lower the residual calibration errors for the updated flux range of interest 665, in this example a signal level between background flux 7 and maximum scene flux 13, essentially shifting the “W” shaped error as a result of calibrating over the new signal range and maximizing the output image accuracy for the current scene of interest. The process 500 as shown in FIG. 5A can then return to step 515 and the computing device can apply the new calibration table data.

It should be noted that the specific values for ranges of interests, pixel responses, thresholds, and signal levels as shown in FIGS. 6A-6D are provided by way of example only. Depending upon various factors such as the type of LEDs used, the capabilities of the infrared focal plane array, the dimensions of the imaging system, and other similar factors, the actual values used for the various quantities and numbers/values as expressed in FIGS. 6A-6D and referenced in the discussion of FIGS. 5A and 5B above can change accordingly.

As noted above, as the infrared LEDs included in the calibration source are able to change intensity quickly, the computing device can be configured to verify that the change in output signal intensity at the calibration source results in an appropriate change to the response (counts) while continuing to monitor for changes in pixel response that exceed a determined threshold. For example, based upon the speed of the intensity changes of the infrared LEDs, the computing device can verify the change to the flux in a single frame as captured by the camera, thereby reducing the amount of time the computing device is not imaging the target scene. This is a valuable improvement over traditional mechanical solutions, as the time used by mechanically positioned calibration devices typically consumes many frame periods, and in that time the system is blind to the target scene. In certain applications such as missile or other similar munition seeking, as the missile approaches the target scene, noticeable changes in the target scene occur more quickly and the guidance system of the missile has less time to compensate for course corrections. As such, it is advantageous to minimize the amount of time the camera is not able to accurately image the target.

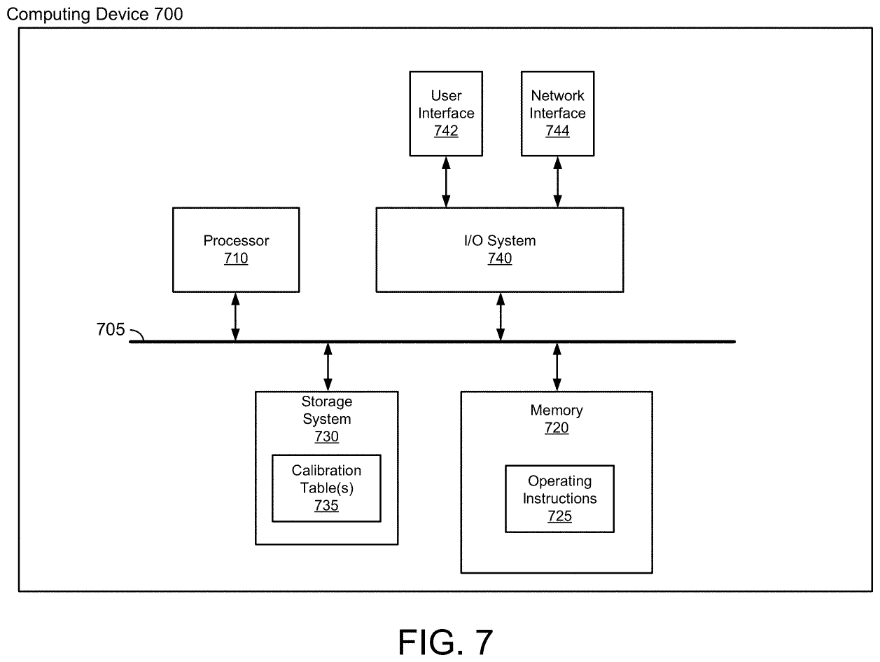

FIG. 7 illustrates a block diagram schematically illustrating a computing device 700, in accordance with certain of the embodiments disclosed herein. For example, computing device 700 can be implemented as the image processing device 125 as described above in regard to FIG. 1. Similarly, the computing device 700 can be configured to perform at least a portion of the process as described above in regard to FIGS. 5A and 5B.

In certain implementations, the computing device 700 can include any combination of a processor 710, a memory 720, a storage system 730, and an input/output (I/O) system 740. As can be further seen, a bus and/or interconnect 705 is also provided to allow for communication between the various components listed above and/or other components not shown. Other componentry and functionality not reflected in the block diagram of FIG. 7 will be apparent in light of this disclosure, and it will be appreciated that other embodiments are not limited to any particular hardware configuration.

The processor 710 can be any suitable processor, and may include one or more coprocessors or controllers, such as an audio processor, a graphics processing unit, or hardware accelerator, to assist in control and processing operations associated with computing device 700. In some embodiments, the processor 710 can be implemented as any number of processor cores. The processor (or processor cores) can be any type of processor, such as, for example, a micro-processor, an embedded processor, a digital signal processor (DSP), a graphics processor (GPU), a network processor, a field programmable gate array or other device configured to execute code. The processors can be multithreaded cores in that they may include more than one hardware thread context (or “logical processor”) per core. Processor 710 can be implemented as a complex instruction set computer (CISC) or a reduced instruction set computer (RISC) processor.

The memory 720 can be implemented using any suitable type of digital storage including, for example, flash memory and/or random-access memory (RAM). In some embodiments, the memory 720 can include various layers of memory hierarchy and/or memory caches as are known to those of skill in the art. The memory 720 can be implemented as a volatile memory device such as, but not limited to, a RAM, dynamic RAM (DRAM), or static RAM (SRAM) device. The storage system 730 can be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

In certain implementations, the memory 720 can include operating instructions 725 that, when executed by processor 710, can cause the processor to perform one or more of the process steps and functions as described herein. For example, if computing device 700 represents the computing device as described above in regard to FIGS. 5A and 5B, at least a portion of operating instructions 725 can include instructions for causing the processor 710 to perform the process as shown in FIGS. 5A and 5B including, for example, causing the processor to apply the correct flux-specific non-uniformity correction tables, monitor scene flux for deviation from calibration, determine if the flux has exceeded a threshold and, if the flux has exceeded the threshold, calculate new calibration temperatures/fluxes and corresponding calibration light source levels, set calibration light levels and collect image data, and calculate new calibration table data and thresholds.

In certain implementations, the storage system 730 can be configured to store one or more calibration tables 735 including, for example, the original calibration table and any newly calculated calibration tables.

The I/O system 740 can be configured to interface between various I/O devices and other components of the computing device 700. I/O devices may include, but not be limited to, a user interface 742 and a network interface 744.

It will be appreciated that in some embodiments, the various components of computing device 700 can be combined or integrated in a system-on-a-chip (SoC) architecture. In some embodiments, the components may be hardware components, firmware components, software components or any suitable combination of hardware, firmware or software.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the methodologies disclosed herein to be implemented. Other componentry and functionality not reflected in the illustrations will be apparent in light of this disclosure, and it will be appreciated that other embodiments are not limited to any particular hardware or software configuration. Thus, in other embodiments the computing device 700 can include additional, fewer, or alternative subcomponents as compared to those included in the example embodiment of FIG. 7.

### FURTHER EXAMPLE EMBODIMENTS

The following examples pertain to further embodiments, from which numerous permutations and configurations will be apparent.

Example 1 includes an infrared imaging system. The system includes an infrared sensor configured to receive light emitted by a target scene to generate image data based on the received light; a light source configured to provide calibrating light to augment scene flux by precise and specifiable amounts, the light source positioned such that an output of the light source is at a pupil of the infrared imaging system, the light source including a first infrared light source configured to output a first light signal at a first wavelength and a first output intensity, and a light-guide structure configured to transmit the first light signal to a pupil of the infrared imaging system; and at least one image processing device. The at least one imaging device is configured to receive the image data generated by the infrared sensor, determine whether image non-uniformities at a current scene flux can be corrected by existing calibration tables, and if the image non-uniformities cannot be corrected by the existing calibration tables, generate an updated calibration table for the infrared imaging system.

Example 2 includes the subject matter of Example 1, wherein the light source further includes a second infrared light source configured to output a second light signal at a second wavelength and a second output intensity and a beam combiner configured to combine the first light signal and the second light signal into a combined beam and direct the combined beam to the light-guide structure, wherein the light-guide structure is configured to transmit the combined beam from the beam combiner to the pupil of the infrared imaging system

Example 3 includes the subject matter of Example 2, wherein the light source further includes a light controller configured to control operation of the first infrared light source and the second infrared light source.

Example 4 includes the subject matter of Example 3, wherein the first and second infrared light sources are first and second infrared LEDs, respectively, and the light controller is further configured to alter at least one of the first wavelength and the first output intensity of the first signal output by the first infrared LED and alter at least one of the second wavelength and the second output intensity of the second signal output by the second infrared LED.

Example 5 includes the subject matter of any of the preceding Examples, wherein the infrared sensor is integrated into a cryocooled infrared imaging device.

Example 6 includes the subject matter of Example 5, wherein the infrared sensor further includes a baffle surrounding an infrared focal plane array and defining a cold stop aperture that limits an amount of light that reaches the infrared focal plane array.

Example 7 includes the subject matter of Example 6, wherein the cryocooled infrared imaging device includes a vacuum assembly configured to house the infrared sensor.

Example 8 includes the subject matter of Example 7, wherein the output of the light source is positioned within the vacuum assembly and adjacent to the cold stop aperture.

Example 9 includes the subject matter of any of the preceding Examples, wherein the infrared imaging system further includes a re-imaging optical system positioned between the infrared sensor and the target scene and configured to condition light emitted by the target scene.

Example 10 includes the subject matter of Example 9, wherein the output of the light source is positioned adjacent to a lens of the re-imaging optical system.

Example 11 includes an infrared imaging system. The infrared imaging system includes a cryocooled infrared imaging device configured to receive light emitted by a target scene to generate image data based on the received light; a re-imaging optical system positioned between the cryocooled infrared imaging device and the target scene and configured to condition light emitted by the target scene; a light source having an output positioned adjacent to a lens of the re-imaging optical system, the light source including a first infrared light source configured to output a first light signal at a first wavelength and a first output intensity, and a light-guide structure configured to transmit the first light signal to a pupil of the infrared imaging system; and at least one image processing device. The at least one imaging device is configured to receive the image data generated by the cryocooled infrared imaging device, determine whether image non-uniformities at a current scene flux can be corrected by existing calibration tables, and if the image non-uniformities cannot be corrected by the existing calibration tables, generate an updated calibration table for the infrared imaging system.

Example 12 includes the subject matter of Example 11, wherein the light source further includes a second infrared light source configured to output a second light signal at a second wavelength and a second output intensity and a beam combiner configured to combine the first light signal and the second light signal into a combined beam and direct the combined beam to the light-guide structure, wherein the light-guide structure is configured to transmit the combined beam from the beam combiner to the pupil of the infrared imaging system.

Example 13 includes the subject matter of Example 12, wherein the light source further includes a light controller configured to control operation of the first infrared light source and the second infrared light source, and wherein the first and second infrared light sources are first and second infrared LEDs, respectively, and the light controller is further configured to alter at least one of the first wavelength and the first output intensity of the first signal output by the first infrared LED and alter at least one of the second wavelength and the second output intensity of the second signal output by the second infrared LED.

Example 14 includes the subject matter of any of preceding Examples 11-13, wherein the cryocooled infrared imaging device includes a baffle surrounding an infrared focal plane array and defining a cold stop aperture that limits an amount of light that reaches the infrared focal plane array.

Example 15 includes the subject matter of Example 14, wherein the cryocooled infrared imaging device further includes a vacuum assembly configured to house an infrared sensor, wherein the output of the light source is positioned within the vacuum assembly and adjacent to the cold stop aperture.

Example 16 includes a computer program product including one or more non-transitory machine-readable mediums encoded with instructions that when executed by one or more processors cause a process to be carried out for providing non-uniformity correction in an infrared imaging system. The process includes generating a non-uniformity calibration table, monitoring image data captured by an infrared sensor, calculating at least one characteristic of the image data that corresponds to one or more errors in non-uniformity correction for comparison against at least one threshold, and if the at least one characteristic exceeds the at least one threshold, generating an updated non-uniformity calibration table for the infrared imaging system by initiating a non-uniformity calibration table process, generating one or more adjusted operating parameters for a light source corresponding to scene flux values of the updated non-uniformity calibration table, and causing transmission of the one or more adjusted operating parameters to a light controller of the light source, thereby altering an output of the light source.

Example 17 includes the subject matter of Example 16, wherein generating the updated non-uniformity calibration table includes updating an existing non-uniformity calibration table based upon current operating conditions.

Example 18 includes the subject matter of Example 16 or 17, wherein generating the updated non-uniformity calibration table includes providing instructions to the light source to step through a plurality of output intensities of an infrared output as generated by the light source, measuring a response by each pixel of the infrared sensor to each of the plurality of output intensities, determining an average scenic flux value for each of the plurality of output intensities, and determining a correspondence between the measured pixel response and the average scenic flux value for each of the plurality of output intensities.

Example 19 includes the subject matter of any of preceding Examples 16-18, wherein the light source includes the light controller, a first infrared light source operably coupled to the light controller and configured to output a first light signal at a first wavelength and a first output intensity, a second infrared light source operably coupled to the light controller and configured to output a second light signal at a second wavelength and a second output intensity, a beam combiner configured to combine the first light signal and the second light signal into a combined beam and direct the combined beam to a light-guide structure, and wherein the light-guide structure is configured to transmit the combined beam from the beam combiner to a pupil of the infrared imaging system.

Example 20 includes the subject matter of Example 19, wherein the light controller is configured to receive the one or more adjusted operating parameters from the one or more processors, determine changes to at least one of the first signal and the second signal based upon the one or more adjusted operating parameters, and adjust at least one of the first signal and the second signal based upon the determined changes.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. In addition, various features, aspects, and embodiments have been described herein. The features, aspects, and embodiments are susceptible to combination with one another as well as to variation and modification, as will be understood in light of this disclosure. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner and may generally include any set of one or more elements as variously disclosed or otherwise demonstrated herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. An infrared imaging system comprising:
an infrared sensor configured to receive light emitted by a target scene to generate image data based on the received light;
a light source configured to provide calibrating light to augment scene flux by precise and specifiable amounts, the light source positioned such that an output of the light source is at a pupil of the infrared imaging system, the light source including
a first infrared light source configured to output a first light signal at a first wavelength and a first output intensity, and
a light-guide structure configured to transmit the first light signal to a pupil of the infrared imaging system; and
at least one image processing device configured to
receive the image data generated by the infrared sensor,
determine whether image non-uniformities at a current scene flux can be corrected by existing calibration tables, and
if the image non-uniformities cannot be corrected by the existing calibration tables, generate an updated calibration table for the infrared imaging system.

2. The infrared imaging system of claim 1, wherein the light source further comprises:
a second infrared light source configured to output a second light signal at a second wavelength and a second output intensity; and
a beam combiner configured to combine the first light signal and the second light signal into a combined beam and direct the combined beam to the light-guide structure,
wherein the light-guide structure is configured to transmit the combined beam from the beam combiner to the pupil of the infrared imaging system.

3. The infrared imaging system of claim 2, wherein the light source further comprises a light controller configured to control operation of the first infrared light source and the second infrared light source.

4. The infrared imaging system of claim 3, wherein the first and second infrared light sources are first and second infrared LEDs, respectively, and the light controller is further configured to:
alter at least one of the first wavelength and the first output intensity of the first signal output by the first infrared LED; and
alter at least one of the second wavelength and the second output intensity of the second signal output by the second infrared LED.

5. The infrared imaging system of claim 1, wherein the infrared sensor is integrated into a cryocooled infrared imaging device.

6. The infrared imaging system of claim 5, wherein the infrared sensor further comprises a baffle surrounding an infrared focal plane array and defining a cold stop aperture that limits an amount of light that reaches the infrared focal plane array.

7. The infrared imaging system of claim 6, wherein the cryocooled infrared imaging device comprises a vacuum assembly configured to house the infrared sensor.

8. The infrared imaging system of claim 7, wherein the output of the light source is positioned within the vacuum assembly and adjacent to the cold stop aperture.

9. The infrared imaging system of claim 1, further comprising a re-imaging optical system positioned between the infrared sensor and the target scene and configured to condition light emitted by the target scene.

10. The infrared imaging system of claim 9, wherein the output of the light source is positioned adjacent to a lens of the re-imaging optical system.

11. An infrared imaging system comprising:
a cryocooled infrared imaging device configured to receive light emitted by a target scene to generate image data based on the received light;
a re-imaging optical system positioned between the cryocooled infrared imaging device and the target scene and configured to condition light emitted by the target scene;
a light source having an output positioned adjacent to a lens of the re-imaging optical system, the light source comprising
a first infrared light source configured to output a first light signal at a first wavelength and a first output intensity, and
a light-guide structure configured to transmit the first light signal to a pupil of the infrared imaging system; and
at least one image processing device configured to
receive the image data generated by the cryocooled infrared imaging device,
determine whether image non-uniformities at a current scene flux can be corrected by existing calibration tables, and
if the image non-uniformities cannot be corrected by the existing calibration tables, generate an updated calibration table for the infrared imaging system.

12. The infrared imaging system of claim 11, wherein the light source further comprises:
a second infrared light source configured to output a second light signal at a second wavelength and a second output intensity; and
a beam combiner configured to combine the first light signal and the second light signal into a combined beam and direct the combined beam to the light-guide structure,
wherein the light-guide structure is configured to transmit the combined beam from the beam combiner to the pupil of the infrared imaging system.

13. The infrared imaging system of claim 12, wherein the light source further comprises a light controller configured to control operation of the first infrared light source and the second infrared light source, and wherein the first and second infrared light sources are first and second infrared LEDs, respectively, and the light controller is further configured to:
alter at least one of the first wavelength and the first output intensity of the first signal output by the first infrared LED; and
alter at least one of the second wavelength and the second output intensity of the second signal output by the second infrared LED.

14. The infrared imaging system of claim 11, wherein the cryocooled infrared imaging device comprises a baffle surrounding an infrared focal plane array and defining a cold stop aperture that limits an amount of light that reaches the infrared focal plane array.

15. The infrared imaging system of claim 14, wherein the cryocooled infrared imaging device further comprises a vacuum assembly configured to house an infrared sensor, wherein the output of the light source is positioned within the vacuum assembly and adjacent to the cold stop aperture.

16. A computer program product including one or more non-transitory machine-readable mediums encoded with instructions that when executed by one or more processors cause a process to be carried out for providing non-uniformity correction in an infrared imaging system, the process comprising:
generating a non-uniformity calibration table;
monitoring image data captured by an infrared sensor;
calculating at least one characteristic of the image data that corresponds to one or more errors in non-uniformity correction for comparison against at least one threshold; and
if the at least one characteristic exceeds the at least one threshold
generating an updated non-uniformity calibration table for the infrared imaging system by initiating a non-uniformity calibration table process,
generating one or more adjusted operating parameters for a light source corresponding to scene flux values of the updated non-uniformity calibration table, and
causing transmission of the one or more adjusted operating parameters to a light controller of the light source, thereby altering an output of the light source.

17. The computer program product of claim 16, wherein generating the updated non-uniformity calibration table comprises updating an existing non-uniformity calibration table based upon current operating conditions.

18. The computer program product of claim 16, wherein generating the updated non-uniformity calibration table comprises:
providing instructions to the light source to step through a plurality of output intensities of an infrared output as generated by the light source;
measuring a response by each pixel of the infrared sensor to each of the plurality of output intensities;
determining an average scenic flux value for each of the plurality of output intensities; and
determining a correspondence between the measured pixel response and the average scenic flux value for each of the plurality of output intensities.

19. The computer program product of claim 16, wherein the light source comprises:
the light controller;
a first infrared light source operably coupled to the light controller and configured to output a first light signal at a first wavelength and a first output intensity;
a second infrared light source operably coupled to the light controller and configured to output a second light signal at a second wavelength and a second output intensity;
a beam combiner configured to combine the first light signal and the second light signal into a combined beam and direct the combined beam to a light-guide structure; and
wherein the light-guide structure is configured to transmit the combined beam from the beam combiner to a pupil of the infrared imaging system.

20. The computer program product of claim 19, wherein the light controller is configured to:
receive the one or more adjusted operating parameters from the one or more processors;
determine changes to at least one of the first signal and the second signal based upon the one or more adjusted operating parameters; and
adjust at least one of the first signal and the second signal based upon the determined changes.
